(19) United States
(12) Patent Application Publication
(10) Pub. No.: US 2011/0182656 A1
(43) Pub. Date: Jul. 28, 2011

(54) SLEEVED COUPLING

(75) Inventor: Larry F. Babb, Grafton, OH (US)

(73) Assignee: EMERSON ELECTRIC CO., St. Louis, MO (US)

(21) Appl. No.: 12/722,561

(22) Filed: Mar. 12, 2010

Related U.S. Application Data
(60) Provisional application No. 61/298,752, filed on Jan. 27, 2010.

(51) Int. Cl. F16B 7/18; F16B 39/00

(52) U.S. Cl. 403/265; 403/299

(57) ABSTRACT

A sleeved coupling for retaining a helically wound cable onto a connector or other component is described. The sleeve is positioned against a shoulder region of a connector and extends over a portion of the cable end. The sleeved coupling significantly increases the torque carrying capability of the resulting cable and connector assembly and achieves performance characteristics similar to welding the cable and connectors together.

### CROSS REFERENCES TO RELATED APPLICATIONS

This application claims priority upon U.S. provisional application Ser. No. 61/298,752 filed on Jan. 27, 2010.

### FIELD OF THE INVENTION

The present application relates to methods and equipment for preventing disengagement of cable in a drain cleaning cable coupling. More particularly, the present application relates to coupling accessories for securing an end of a drain cleaning cable, commonly referred to as a “snake,” to a coupling or other connection component typically used with sectional cables. Typically, such cables can be single integral cables, or selectively adjustable lengths formed by engaging two or more cable sections or portions together.

### BACKGROUND OF THE INVENTION

Tools for cleaning drains include plumbers cables which are nearly always used with specialized tools integrated into or carried on the free or distal end thereof. One such simple tool is a bulb auger formed by the free end of the cable. Other specialized tools include removable hard tools such as chain knockers, augers such as funnel or hook augers, and cutters such as spade, saw tooth, spiral saw tooth or shark tooth cutters. Soft tools may be used with the cables as well. These typically include specialized brushes and the like for finish cleaning of passageways. The specialized tools are typically selectively connected to the distal working end of the cable using quick connect couplings or other similar mechanisms. Sectional drain cleaning cables include similar couplings on opposite ends thereof so that the cable can be easily carried to the job site in short sections then assembled end-to-end as needed to service the drain.

For best results, the cables are preferably rotated while within the target pipe or drain. Various prime mover devices have been used for this purpose including hand operated crank-type devices for homeowner applications and electric motor prime movers, such as for example sectional or drum machines, for larger or industrial applications.

In a typical drum machine set up, a rotatable drum carries a reserve of the snake with a working portion of the snake extending from the drum often through a linear feed control device. The user selectively extends the snake into the clogged pipe using the linear feed control mechanism. The feed control is also used afterwards to retract the cable from the pipe. In a sectional machine, the pay out of cable is by hand. Regardless of the device, for best results, linear cable feeding typically occurs while the prime mover rotates the cable to help it auger through the obstruction. Further, the snake may be used in a mode of simply rotating within the pipe without linear motion for extended periods in order to generally open the pipe along the length of the snake by lateral movement thereof within the pipe as bends in the cable “sweep” past the inner walls of the pipe. Thereafter, the operator may retract the snake out from the pipe workpiece and back onto the rotating drum by hand feed or by selectively operating the linear feed control. Special soft tools may be used as well on the end of the cable, such as a brush to polish the inner walls of the pipe.

A typical coupling for selectively joining two drain cleaning cables together is illustrated in FIGS. 1 and 2. A first section of cable 10 having a male connection component 20 can be selectively engaged with a second section of cable 30 having a female connection component 40. Typically, the cables 10, 30 have a helical configuration. Although a variety of engagement configurations can be used, one such configuration includes a key 45 that upon depressing or rotating, allows the male component 20 to be fully received in the female component 40. Return of the key to its previous position securely locks the components 20 and 40 together, thereby operably engaging the cable sections 10 and 30 together as shown in FIG. 2.

FIG. 3 illustrates in greater detail, the male component 20 and the female component 40 described in conjunction with FIGS. 1 and 2. FIG. 3 illustrates these components without their associated cables for greater clarity. Each component includes a longitudinal member extending from the coupling component which receives and engages an end of a cable. Thus, the male component 20 includes a longitudinal member 26. And, the female component 40 includes a longitudinal member 46. Each longitudinal member defines a threaded or grooved region along its outer periphery. The configuration of the threaded region corresponds to the helical configuration of the associated cable end. Therefore, the longitudinal member 26 of the male component 20 defines a threaded region 28 corresponding to, i.e. adapted to fittingly receive and engage, the end of cable 10. Similarly, the longitudinal member 46 of the female component 40 defines a threaded region 48 corresponding to the end of cable 30.

FIG. 4 illustrates a union component 50 having oppositely extending longitudinal members 76a and 76b for receiving and engaging ends of cables. Each member 76a and 76b defines threaded regions 78a and 78b, respectively.

The ends of helically wound cables are attached to any of the longitudinal members 26, 46, 76a, or 76b for example, by rotating the component or union relative to the cable end, or vice versa. The cable end will essentially “wind” itself about the longitudinal member as it is slidably received and engaged within the threaded region. This operation is continued until the cable end is seated against and generally contacting an adjacent shoulder of the component, such as a shoulder 42 of the component 40 depicted in FIG. 3 or a shoulder 52 of the union 50 shown in FIG. 4. For certain cable connections, an interference fit between the end of a wound cable and connector about which the cable is wound, is sufficient to retain the cable end to the connector.

If the cable end is not sufficiently retained to the component, during operation of a drain cleaning machine and powered rotation of the cable, the cable end has a tendency to “jump” over or otherwise become disengaged from its associated component. Alternatively or in addition, one or more coils in the cable, typically located along the longitudinal member of the associated coupling will “grow” or radially expand. As will be appreciated, this is undesirable and can result in cable binding and in certain situations, loss of torque transmission. Therefore, it may be desirable to further secure the cable end to the associated component due to the high levels of torque that are transmitted via the cable and connection components.

Once the cable end is appropriately seated against its corresponding connection component, certain equipment suppliers advocate welding the cable in place. Not all equipment suppliers weld their cables. However, it is believed that welding increases robustness of the resulting assembly. Welding of the cable generally occurs at the shoulder of the connection component and also along at least a portion of the longitudinal member contacting the cable. This practice serves to provide a secure and reliable connection between the cable and its associated component.

Although providing the resulting assembly with excellent performance and connection reliability, welding can be difficult particularly for certain situations if welding is performed in the field. In addition, the appearance of the resulting weld may create issues with customers as to the quality of the weld and the connection between the cable and associated component. Further, welding requires a trained operator and increases time and labor associated with a project or cable product.

In view of these and other reasons, it would be desirable to provide an assembly for conveniently and easily securing an end of a cable to an associated connector or other component. In particular, it would be desirable to provide a non-welded means for securing a cable end to an associated coupling.

### SUMMARY OF THE INVENTION

The difficulties and drawbacks associated with previously known practices are overcome in the present invention for a sleeved coupling assembly and related method. The coupling can be in the form of a female or male end connector, although in no way is the invention limited to such. Generally, any connector can be used having a longitudinally extending member which has a helically extending groove for receiving an end of a helically wound cable. The coupling assembly includes a sleeve that extends over a cable end upon the cable being disposed in the groove of the longitudinal member. The sleeve serves to securely retain the cable and eliminates the requirement of welding the cable to the connector.

In one aspect, the present invention provides a sleeved coupling assembly for providing non-welded attachment to an end of a helically wound drain cleaning cable. The assembly comprises a connection component defining a first face and an oppositely directed second face. The assembly also comprises a longitudinal member extending from the second face of the connection component. The longitudinal member defines a helical groove extending from a distal end of the member to the second face of the connection component. The groove is configured to threadedly receive an end of a helically wound drain cleaning cable to be attached to the assembly. The assembly also comprises a generally cylindrical sleeve extending from the second face of the connection component and concentrically positioned about the longitudinal member thereby defining an annular hollow region between the longitudinal member and an inner circumferential wall of the sleeve. The annular hollow region is sized to fittingly engage an end of a helically wound drain cleaning cable threadedly received in the groove of the longitudinal member. The inner wall of the sleeve is free of one or more threaded regions or helical grooves.

In yet another aspect, the present invention provides a sleeved coupling assembly for an end of a helically wound drain cleaning cable. The assembly comprises a connection component having a first face and an oppositely directed second face. The assembly also comprises a longitudinal member extending from the second face of the connection component. The longitudinal member defines a helical groove extending from a distal end of the member to the second face of the connection component. The assembly additionally comprises a helically wound cable disposed within the helical groove of the longitudinal member and extending along the length of the longitudinal member. And, the assembly further comprises a generally cylindrical sleeve extending from the second face of the connection component and along at least a portion of the length of the longitudinal member. The sleeve defines an inner circumferential wall. The sleeve is sized and positioned such that the inner circumferential wall contacts at least a majority of the outermost surface regions of the helically wound cable along the length of the longitudinal member. The inner circumferential wall is free of one or more threaded regions or helical grooves. As a result of (i) contact between the inner circumferential wall of the sleeve and at least a majority of the outermost surface regions of the helically wound cable along the length of the sleeve and (ii) the cable being disposed within the helical groove of the longitudinal member, the cable is securely attached and retained to the connection component and free of any welding, brazing, or soldering along the region of its engagement with the longitudinal member.

In yet another aspect, the present invention provides a welding-free, brazing-free, and soldering-free method for attaching a distal end of a helically wound cable to a connection component having a longitudinal member extending from the connection component. The method comprises providing a helically wound cable defining a distal end. The method also comprises providing a connection component having a longitudinal member extending from a face of the connection component. The longitudinal member defines a helical groove along the length of the member. The longitudinal member and the helical groove are configured to receive the helically wound cable. The method additionally comprises positioning the cable onto the longitudinal member such that the cable is disposed in the helical groove defined by the longitudinal member and the cable extends over the length of the longitudinal member. And, the method further comprises placing a generally cylindrical sleeve over the cable such that the sleeve extends from the face of the connection component and extends over at least a majority of the length of the longitudinal member. The sleeve defines an inner circumferential wall sized so that at least a majority of the outermost surface regions of the cable along the length of the longitudinal member contact the inner wall, whereby the attachment method is free of welding, brazing, or soldering the cable to the connection component.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIGS. 1 and 2 illustrate a typical coupling assembly for selectively attaching ends of helically wound cables to one another.

FIG. 3 illustrates the coupling components of FIGS. 1 and 2, without cables.

FIG. 4 illustrates a typical union component for attaching two cable ends together.

FIG. 5 is a schematic partial cross sectional view of a preferred embodiment sleeved coupling retaining a coiled cable end in accordance with the present invention.

FIG. 6 is a perspective view of a preferred embodiment sleeve in accordance with the present invention.

FIG. 7 is a schematic partial cross sectional view of another preferred embodiment sleeved coupling shown without a cable, in accordance with the present invention.

FIG. 8 is a schematic end view of the preferred embodiment sleeved coupling without a cable in FIG. 7, taken from line 8-8.

FIG. 9 is a schematic partial cross sectional view of another preferred embodiment sleeved coupling retaining a coiled cable end in accordance with the present invention.

FIG. 10 is a schematic partial cross sectional view of another preferred embodiment sleeved coupling retaining a coiled cable end in accordance with the present invention.

FIG. 11 is a schematic partial cross sectional view of another preferred embodiment sleeved coupling retaining a coiled cable end in accordance with the present invention.

### DETAILED DESCRIPTION OF THE EMBODIMENTS

The present invention provides a unique assembly and method for securely attaching a helically wound cable such as a drain cleaning cable, to a connection component without welding, brazing, or soldering. The assembly generally comprises a connection component, a longitudinal member extending from the connection component, the member having a helically extending groove along its outer surface and a sleeve also extending from the connection component. The sleeve is preferably concentrically positioned relative to the longitudinal member to thereby define a generally annular hollow region between the sleeve and the longitudinal member. The assembly can further comprise an end portion of a helically wound cable that is positioned upon the longitudinal member, and particularly, in which the cable is disposed within the helical groove defined along the outer surface of the longitudinal member.

The assembly securely retains the cable by the sleeve extending over the cable along at least a majority of the length of the longitudinal member. In a most preferred embodiment, the sleeve defines an inner circumferential wall that is free of any threads or other helically extending grooves. Instead, the inner wall of the sleeve is relatively smooth and may be finished. The sleeve is sized such that upon positioning a cable end within the noted annular region, at least a majority of the outer surface regions of the coils of the cable contact the inner wall. This serves to securely retain the distal end of the cable without having to weld, braze, or solder the cable onto or within the connection component and particularly the longitudinal member.

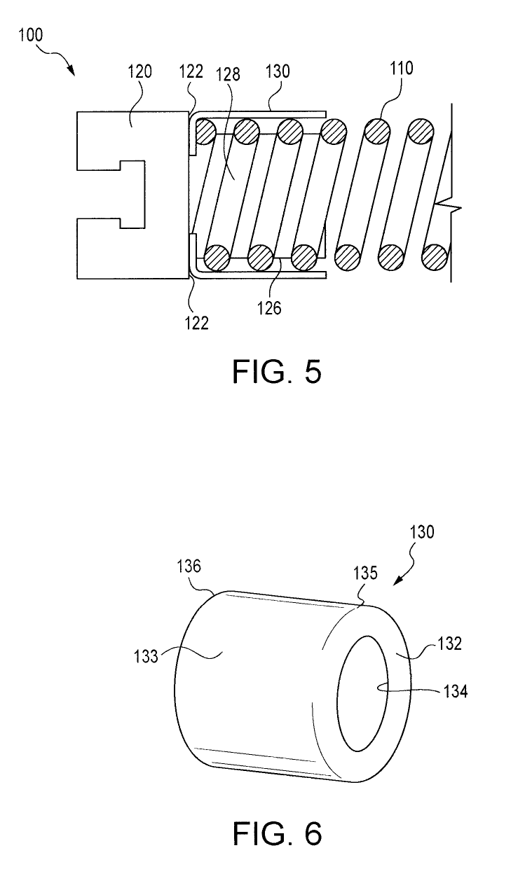

FIG. 5 illustrates a preferred embodiment sleeved coupling 100 in accordance with the present invention. The coupling comprises a connection component 120 which although depicted as having a female configuration, may be in the form of a male connector or employ another or different configuration. Representative examples of connector types include for example “L” connectors and “G” connectors as known in the art. The coupling 100 also comprises one or more longitudinal members 126 extending from the connection component 120. The longitudinal member 126 defines a threaded region 128 for receiving and engaging a helically wound cable 110 disposed on the member 126 and preferably within a helically extending groove or recessed region constituting the threaded region 128. The longitudinal member 126 is secured to, and preferably integral with, the connection component 120. The coupling 100 further comprises a sleeve 130. The sleeve 130 is sized, shaped and configured to nest against a shoulder 122 of the component 120 and extend in the same or substantially the same direction as the longitudinal member 126. The sleeve 130 extends along a portion of the length of the member 126 and preferably along the entire length of the member 126. It is also contemplated that the sleeve 130 may extend beyond the member 126. The sleeve 130 is preferably sized so that the sleeve 130 contacts one or more outer regions of the coils of the cable 110. However, it will be appreciated that the present invention includes other arrangements and is not limited to such particular sizing.

FIG. 6 illustrates the preferred embodiment sleeve 130 separate from a connection component. The sleeve 130 is preferably cylindrically shaped and defines a proximal end 132 which upon installation or incorporation in an associated component, preferably contacts and is seated against the component shoulder such as the shoulder 122 of the component 120 in FIG. 5. The sleeve 130 also defines an open distal end 136 opposite the proximal end 132. The distal end 136 is preferably flat and relatively smooth. Defined at the proximal end 132 is an aperture 134. The aperture 134 is preferably concentrically located along the proximal end 132 and centered along a longitudinal axis of the sleeve 130. The aperture 134 is sized and shaped to receive and fit over the longitudinal member of the associated component such as member 126 of the component 120 depicted in FIG. 5. A curved edge or transition region 135 may be provided between a circumferential wall 133 and the proximal end 132.

Upon appropriate placement of the sleeve 130 into a position as shown in FIG. 5, the cable 110 is secured to the component 120 and particularly, about the longitudinal member 126. The sleeve 130 prevents the cable from becoming disengaged from the member 126 or the coils of the cable 110 adjacent to the cable end, from expanding. And thus, use of the sleeve 130 eliminates the need for welding the cable to the component. Although in many applications, frictional engagement between the sleeve 130 and the outer surface of the cable, will be sufficient to retain the sleeve in its position about the cable and/or longitudinal member, it is also contemplated that the sleeve could be pressed or crimped thereabout to further promote engagement. In addition, other affixment techniques are contemplated such as the use of adhesives.

The present invention includes variations of the sleeve and sleeved coupling described and shown in FIGS. 5 and 6. For example, instead of a separately formed sleeve, a sleeve that is integral with or integrally formed with a coupling component is also contemplated.

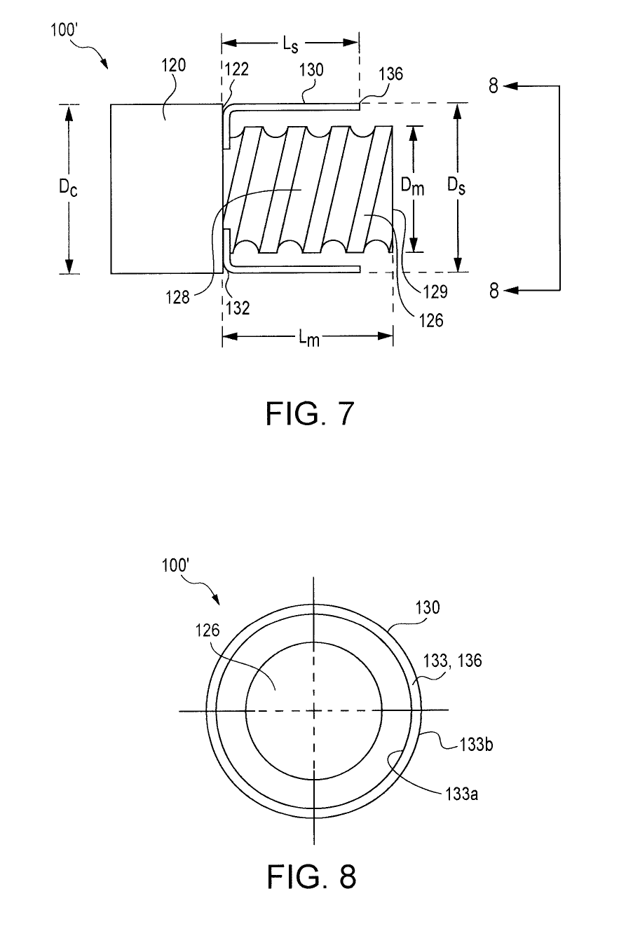

FIGS. 7 and 8 illustrate another preferred embodiment coupling assembly 100′ in accordance with the present invention. The assembly 100′ generally includes like components as in previously described coupling 100 depicted in FIG. 5, and so like reference numerals are used. The assembly 100′ is illustrated and described herein to address additional features as follows. Although the following description is provided in terms of the coupling assembly 100′, it will be appreciated that the following description also applies to any coupling assembly in accordance with the present invention.

The length of the sleeve 130, generally defined as the distance between the proximal end 132 and the distal end 136 and denoted as L_{S} in FIG. 7, is preferably at least greater than about 75% of the length of the longitudinal member 126, denoted L_{M}. Generally, the length of the longitudinal member 126 is the distance between the shoulder 122 of the connection component 120 and a distal end 129 of the member 126, such measurement taken parallel to the longitudinal axis of the member 126. The length of the sleeve 130 is more preferably at least 90% of the length of the member 126. For many applications, the length of the sleeve 130 is approximately equal to the length of the member 126. And, for particular applications, it is contemplated that the length of the sleeve 130 could be greater than the length of the longitudinal member 126.

The outer diameter of the sleeve 130, shown as D_{S} in FIG. 7, is preferably less than or approximately equal to the diameter of the connection component 120, shown as D_{C} in FIG. 7. As will be appreciated, this is desirable to reduce the potential for interference between external objects and the sleeve 130. Thus, preferably, as the coupling assembly 100′ is advanced during a working operation, the front profile of the sleeve 130 is the same or smaller than that of the connection component 120.

Another feature of the preferred embodiment coupling assemblies is the provision of a relatively smooth inner face for the inner circumferential wall of the sleeve. That is, the inner face of the sleeve wall is preferably free of threads or helically extending grooves. Specifically, referring to FIG. 8, an end view of the preferred embodiment connection assembly 100′ is shown. The distal end 136 of the circumferential wall 133 is illustrated. That wall defines an inner face 133a and an oppositely directed outer face 133b. It is most preferred that the inner face 133a be free of any threads, grooves, or other recessed regions. In the event that the inner wall of the sleeve included such threads or grooves, it would be difficult to achieve appropriate alignment between such threads and the threaded region 128 defined by the longitudinal member 126. As a result, haphazard contact would occur between the inner face of the sleeve and the outer regions of a coiled cable upon positioning the cable within the noted annular region. Instead, the provision of a relatively smooth surface for the inner sleeve wall is preferred.

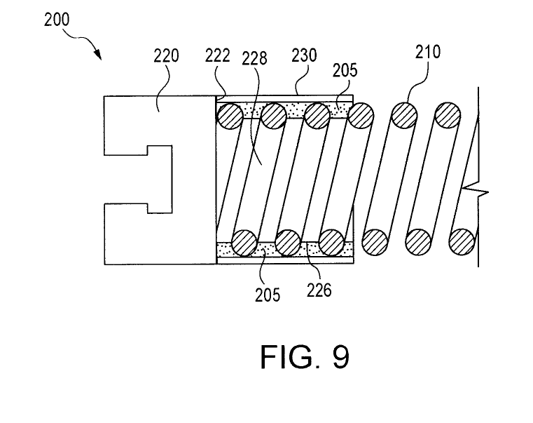

FIG. 9 illustrates another preferred embodiment sleeved coupling 200 in accordance with the present invention. The coupling comprises a connection component 220 which although depicted as having a female configuration, may be in the form of a male connector or employ another or different configuration. The coupling 200 also comprises one or more longitudinal members 226 extending from the connection component 220. The longitudinal member 226 defines a threaded region 228 for receiving and engaging a helically wound cable 210 disposed on the member 226 and preferably within a helically extending groove or recessed region constituting the threaded region 228. The longitudinal member 226 is secured to, and preferably integral with, the connection component 220. The coupling 200 further comprises a sleeve 230. The sleeve 230 is sized, shaped and configured to abut against a shoulder 222 of the component 220 and extend in the same or substantially the same direction as the longitudinal member 226. The sleeve 230 extends along a portion of the length of the member 226 and preferably along the entire length of the member 226. It is also contemplated that the sleeve 230 may extend beyond the member 226. The sleeve 230 is preferably sized so that the sleeve 230 contacts one or more outer regions of the coils of the cable 210. However, it will be appreciated that the present invention includes other arrangements and is not limited to such particular sizing.

A significant feature of the sleeved coupling 200 illustrated in FIG. 9 is the incorporation of an adhesive 205 in the region between an inner face of the sleeve 230 and the outer surface of the end of the coiled cable 210 and exposed outer surface of the longitudinal member 226. The adhesive can be incorporated within the annular hollow region defined between the outer surface of the longitudinal member and the inner face of the sleeve wall. Specifically, the adhesive is incorporated along the interface between the cable and one or both of the longitudinal member and the sleeve. The use of adhesive 205 may serve to further strengthen the resulting assembly and affixment of the cable 210 to the connection component 200. A wide array of adhesives may be used for the adhesive 205. Representative examples for adhesive 205 include but are not limited to hot melt adhesives, epoxy adhesives, polyurethane adhesives, sealants, thermoset adhesives, UV curing adhesives, silicon adhesives, acrylic adhesives, and other chemical adhesives. Preferred adhesives include but are not limited to acrylic adhesives and epoxy. Instead of or in addition to the noted adhesives, one or more chemical bonding agents may be used.

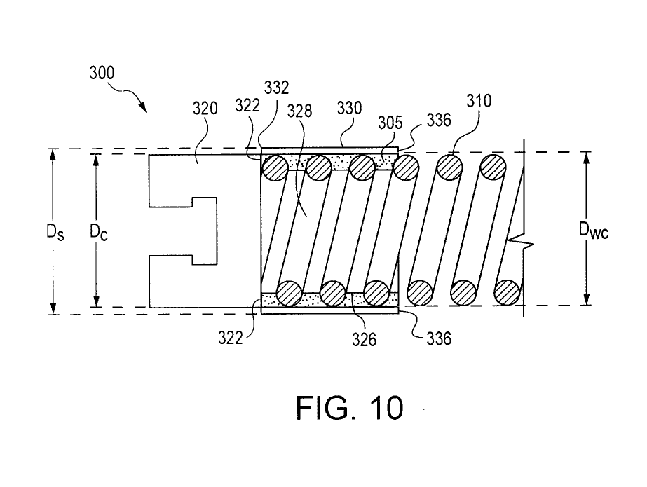

FIG. 10 illustrates another preferred embodiment sleeved coupling 300 in accordance with the present invention. The coupling comprises a connection component 320 which although depicted as having a female configuration, may be in the form of a male connector or employ another or different configuration. The coupling 300 also comprises one or more longitudinal members 326 extending from the connection component 320. The longitudinal member 326 defines a threaded region 328 for receiving and engaging a helically wound cable 310 disposed on the member 326 and preferably within a helically extending groove or recessed region constituting the threaded region 328. The longitudinal member 326 is secured to, and preferably integral with, the connection component 320. The coupling 300 further comprises a sleeve 330.

The sleeve 330 is sized, shaped, and configured to slide over the end of the connector 320. As shown in FIG. 10, one end of the sleeve 330 is generally positioned in-line with a shoulder 322 of the connector 320. The other end 336 of the sleeve 330 generally extends to be adjacent to the distal end of the longitudinal member 326. In certain applications it may be preferred to utilize adhesive in the coupling 300. Although not necessary, the use of an adhesive promotes retention of the cable 310 to the connection component 320 and/or the longitudinal member 326. In the event that the coupling 300 includes adhesives, an effective amount of adhesive 305 is used to retain and secure the sleeve 330 about the region of the cable 310 along the longitudinal member 326 as shown in FIG. 10. In this particular embodiment, it will be noted that the outer diameter of the wound cable designated as D_{WC} in FIG. 10 is equal or approximately so to the outer diameter of the connector D_{C}. It will be understood that references to the diameter of the helically wound cable refer to the overall wound diameter of the cable and not to the diameter of individual strands or sections of the cable material. It will be appreciated that in order to slide or otherwise position the sleeve 330 about the outer periphery of the cable 310 as shown, the inner diameter of the sleeve 330 must accommodate and generally be larger than the outer diameter of the wound cable and the connector, i.e. D_{WC} and D_{C}. As a result of the thickness of the wall of the sleeve 330, the outer diameter of the sleeve 330 D_{S} exceeds the outer diameter of the connector D_{C}. Thus, when advancing the assembly 300 such as during a drain cleaning operation, the leading edge 332 of the sleeve could conceivably contact an obstruction or other object in the environment. Although this embodiment 300 is acceptable for many applications, the present invention provides yet another alternative preferred embodiment.

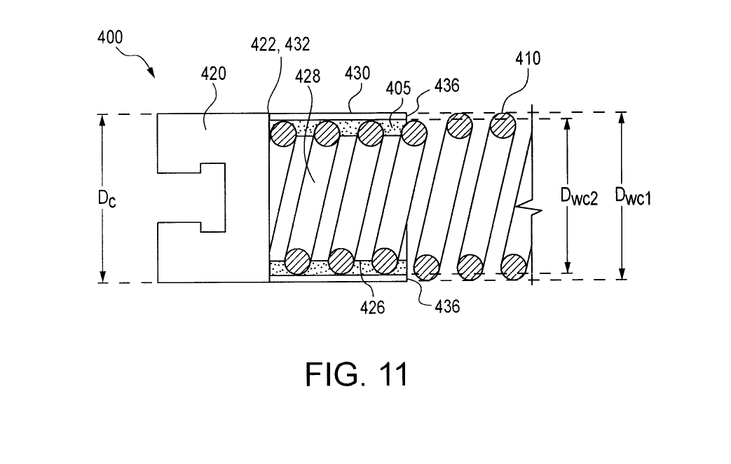

FIG. 11 illustrates another preferred embodiment sleeved coupling 400 in accordance with the present invention. The coupling comprises a connection component 420 which although depicted as having a female configuration, may be in the form of a male connector or employ another or different configuration. The coupling 400 also comprises one or more longitudinal members 426 extending from the connection component 420. The longitudinal member 426 defines a threaded region 428 for receiving and engaging a helically wound cable 410 disposed on the member 426 and preferably within a helically extending groove or recessed region constituting the threaded region 428. The longitudinal member 426 is secured to, and preferably integral with, the connection component 420. The coupling 400 further comprises a sleeve 430.

As shown, the sleeve 430 extends along the length of the longitudinal member 426. As previously noted in conjunction with the assembly 300 depicted in FIG. 10, adhesive may optionally be used in the coupling 400. An effective amount of adhesive 405 may be used to retain and secure the sleeve 430 about the region of the cable 410 along the longitudinal member 426 as depicted in FIG. 11. In this embodiment, it will be appreciated that the outer diameter of the wound cable decreases from an outer diameter D_{WC1} which corresponds to the outer diameter of the cable along its exposed length, to an outer diameter D_{WC2} which is less than D_{WC1} and is the outer diameter of the cable for the portion of cable extending along the longitudinal member 426. This preferred embodiment enables the outer diameter of the sleeve 430 to be the same or approximately so, or less, than the outer diameter of the connector 420, shown as D_{C} in FIG. 11. In this embodiment, the end 432 of the sleeve 430 abuts the shoulder 422 of the connector 420. And, the distal end 436 of the sleeve 430 is adjacent to the distal end of the longitudinal member 426.

Thus, several observations may be made with respect to the preferred embodiment 400 illustrated in FIG. 11. In one aspect, the cable 410 is formed such that its terminal end has a smaller diameter than the diameter at other regions of the cable. Although the invention includes a wide range of diameter reductions, it is generally preferred that the reduction be from about 1% to about 10% and most preferably from about 2% to about 5% of D_{WC1} shown in FIG. 11. Thus the diameter of the cable along at least a majority of the length of the longitudinal member is about 90% to about 99% of the diameter, and preferably about 95% to about 98% of the diameter of the cable along its exposed regions. The portion of the cable 410 exhibiting this reduced diameter, i.e. D_{WC2}, is generally equal to the length of the longitudinal member 426. This length typically corresponds to about 3 to about 6 coils of the cable 410. However, it will be appreciated that in no way is the invention limited to such. As the terminal end of the cable 410 is formed to a smaller diameter, it is also contemplated that the diameter of the longitudinal member 426 may also be formed or otherwise modified to be slightly reduced to better receive or accommodate the end of the cable 410.

As noted herein, the present invention also includes an embodiment in which a sleeve is positioned over a terminal end of a cable engaged with a longitudinal member of a connector, and the sleeve is radially compressed about the outer periphery of the cable. Radial compression could be performed by a hydraulic press tool as known in the art. This affixment technique could be used in conjunction with the use of adhesive along the interface of the sleeve, cable, and longitudinal member.

The sleeve can be formed from nearly any material suitable for end-use conditions in which drain cleaning cables are used. Typically, metals such as a mild steel are preferred. However, it is also contemplated that metals such as aluminum, brass, copper, tin, nickel, titanium, and alloys thereof could be used. In particular, it is also noted that stainless steel could be used for forming the sleeve. If stainless steel is utilized, representative grades such as Grade 304, Grade 316, and Grade 410 can be used. Representative aluminum grades can include for example 1100-H14, 3003-H14, 5052-H32, and 6061-T6. Generally, any thickness of the selected metal can be used for the sleeve, so long as the sleeve exhibits the requisite strength and rigidity for the end use application. Typical thickness gauges include from about 3 to about 31 with 8 to 30 being preferred for most steels. It is also contemplated that the sleeve could be formed from any suitable non-metal material. Generally, the material should not exhibit excessive creep or deformation when placed under a load. Accordingly, most plastics are thus not preferred unless they are appropriately engineered or formulated to withstand such loading. For example, engineered materials typically including composites or other strength promoting agents or structures could be used for the sleeve. Certain fiberglass materials or materials including structural windings may be used for the sleeve. The outer surfaces of the sleeve, the connector, and/or the longitudinal member can be coated with one or more protective coatings. For example, an anti-corrosive coating can be applied to the inner and outer faces and end regions of the sleeve.

The present invention includes sleeves or like components that are in a wide array of different forms. For example, sleeves that do not include a relatively continuous circumferential wall may be used. For example, a sleeve component having an outer wall having a plurality of openings such as a screen or other apertured wall could be utilized. It is also contemplated that a sleeve component could be formed from one or more windings appropriately positioned about the outer periphery of a cable.

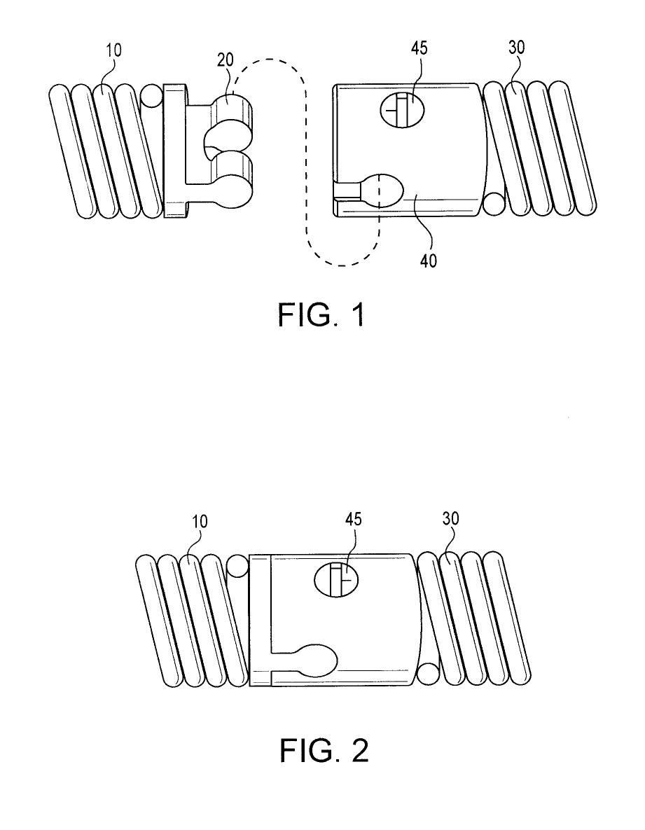

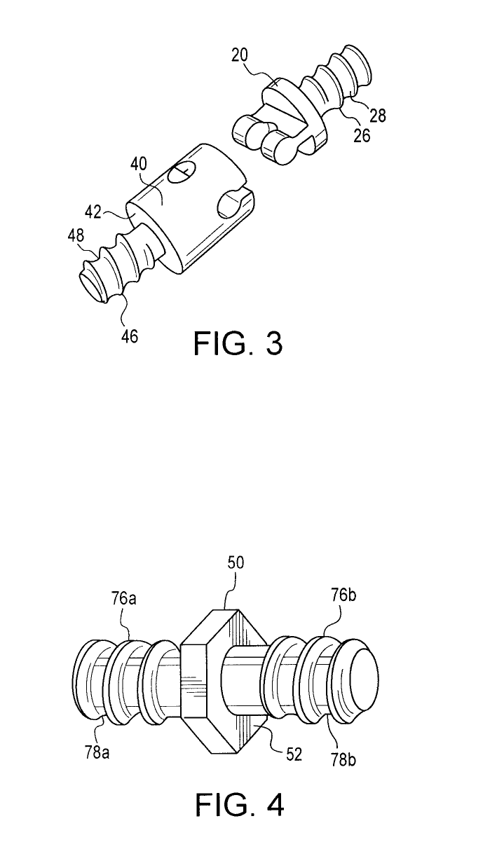

Incorporating the present invention sleeve into a cable connection assembly provides performance equivalent to welding. Incorporating such sleeves greatly enhances the torque-carrying capability of non-welded cable connections. The sleeve can be incorporated and used with an existing connector assembly such as those depicted in FIGS. 1-4 for example. Referring to FIG. 5 for example, the longitudinal member 126 of the connector 120 is inserted into the opening or aperture 134 defined along the proximal end 132 of the sleeve 130, such as shown in FIG. 6. The sleeve and connector are then positioned adjacent to one another, preferably so that the end 132 contacts a shoulder region of the connector, such as the shoulder 122 of the connector 120 in FIG. 5 or the shoulder 52 of the union component 50 in FIG. 4. Alternatively, the sleeve can be integrally formed with the connector. For embodiments using adhesive, it will be appreciated that the adhesive can be incorporated into the assembly at nearly any phase. After incorporation of the adhesive, one or more curing operations can be performed if necessary.

Many other benefits will no doubt become apparent from future application and development of this technology.

All patents, published applications, and articles noted herein are hereby incorporated by reference in their entirety.

It will be understood that any one or more feature or component of one embodiment described herein can be combined with one or more other features or components of another embodiment. Thus, the present invention includes any and all combinations of components or features of the embodiments described herein.

As described hereinabove, the present invention solves many problems associated with previous type devices. However, it will be appreciated that various changes in the details, materials and arrangements of parts, which have been herein described and illustrated in order to explain the nature of the invention, may be made by those skilled in the art without departing from the principle and scope of the invention, as described herein and claimed in the following claims.

What is claimed is:

1. A sleeved coupling assembly for providing non-welded attachment to an end of a helically wound drain cleaning cable, the assembly comprising:
a connection component defining a first face and an oppositely directed second face;
a longitudinal member extending from the second face of the connection component, the longitudinal member defining a helical groove extending from a distal end of the member to the second face of the connection component, the groove configured to threadedly receive an end of a helically wound drain cleaning cable to be attached to the assembly; and
a generally cylindrical sleeve extending from the second face of the connection component and concentrically positioned about the longitudinal member thereby defining an annular hollow region between the longitudinal member and an inner circumferential wall of the sleeve, wherein the annular hollow region is sized to fittingly engage an end of a helically wound drain cleaning cable threadedly received in the groove of the longitudinal member, the inner wall of the sleeve being free of one or more threaded regions or helical grooves.

2. The sleeved coupling of claim 1 wherein the sleeve extends from the second face of the connection component, a distance of at least 75% of the length of the longitudinal member.

3. The sleeved coupling of claim 2 wherein the sleeve extends a distance of at least 90% of the length of the longitudinal member.

4. The sleeved coupling of claim 3 wherein the sleeve extends a distance approximately equal to the length of the longitudinal member.

5. The sleeved coupling of claim 3 wherein the sleeve extends a distance greater than the length of the longitudinal member.

6. The sleeved coupling assembly of claim 1 wherein the connection component is generally cylindrical and the diameter of the sleeve is less than the diameter of the connection component.

7. The sleeved coupling assembly of claim 1 wherein the connection component is generally cylindrical and the diameter of the sleeve is approximately the same as the diameter of the connection component.

8. The sleeved coupling assembly of claim 1 wherein the sleeve is integral with the connection component.

9. The sleeved coupling assembly of claim 1 wherein the sleeve is non-integral with the connection component.

10. The sleeved coupling assembly of claim 9 wherein the sleeve defines a proximal end that contacts the second face of the connection component and an oppositely directed distal end defining a first opening, the proximal end defining a circular aperture sized to receive the longitudinal member extending therethrough, the diameter of the first opening being greater than the diameter of the circular aperture.

11. The sleeved coupling of claim 1 further comprising:
adhesive disposed in the annular hollow region.

12. The sleeved coupling of claim 1 further comprising:
a helically wound cable disposed within the annular hollow region between the interior circumferential face of the sleeve and the longitudinal member, wherein the cable is free of welding, brazing and soldering along the region of its engagement with the sleeved coupling assembly.

13. The sleeved coupling of claim 12 further comprising:
adhesive disposed within the annular hollow region along with the helically wound cable disposed therein.

14. The sleeved coupling of claim 12 wherein a portion of the cable extending along at least a majority of the length of the longitudinal member has an outer diameter that is less than an exposed portion of the cable.

15. The sleeved coupling of claim 14 wherein the diameter of the portion of the cable extending along the longitudinal member is from 90% to 99% of the diameter of the exposed portion of the cable.

16. A sleeved coupling assembly for an end of a helically wound drain cleaning cable, the assembly comprising:
a connection component having a first face and an oppositely directed second face;
a longitudinal member extending from the second face of the connection component, the longitudinal member defining a helical groove extending from a distal end of the member to the second face of the connection component;
a helically wound cable disposed within the helical groove of the longitudinal member and extending along the length of the longitudinal member;
a generally cylindrical sleeve extending from the second face of the connection component and along at least a portion of the length of the longitudinal member, the length of the sleeve being the distance which the sleeve extends along the longitudinal member, the sleeve defining an inner circumferential wall, the sleeve sized and positioned such that the inner circumferential wall contacts at least a majority of the outermost surface regions of the helically wound cable along the length of the sleeve, the inner circumferential wall being free of one or more threaded regions or helical grooves;
whereby as a result of (i) contact between the inner circumferential wall of the sleeve and at least a majority of the outermost surface regions of the helically wound cable along the length of the sleeve, and (ii) the cable being disposed within the helical groove of the longitudinal member, the cable is securely attached and retained to the connection component and free of any welding, brazing, or soldering along the region of its engagement with the longitudinal member.

17. The sleeved coupling of claim 16 wherein the length of the sleeve is at least 75% of the length of the longitudinal member.

18. The sleeved coupling of claim 17 wherein the length of the sleeve is at least 90% of the length of the longitudinal member.

19. The sleeved coupling of claim 18 wherein the sleeve extends a distance approximately equal to the length of the longitudinal member.

20. The sleeved coupling of claim 18 wherein the length of the sleeve is greater than the length of the longitudinal member.

21. The sleeved coupling assembly of claim 16 wherein the connection component is generally cylindrical and the diameter of the sleeve is less than the diameter of the connection component.

22. The sleeved coupling assembly of claim 16 wherein the connection component is generally cylindrical and the diameter of the sleeve is approximately the same as the diameter of the connection component.

23. The sleeved coupling assembly of claim 16 wherein the sleeve is integral with the connection component.

24. The sleeved coupling assembly of claim 16 wherein the sleeve is non-integral with the connection component.

25. The sleeved coupling assembly of claim 24 wherein the sleeve defines a proximal end that contacts the second face of the connection component and an oppositely directed distal end defining a first opening, the proximal end defining a circular aperture sized to receive the longitudinal member extending therethrough, the diameter of the first opening being greater than the diameter of the circular aperture.

26. The sleeved coupling assembly of claim 16 further comprising:
adhesive disposed generally between the longitudinal member and the inner circumferential wall of the sleeve and at least partially in contact with the helically wound cable to thereby further secure the cable to the connection component.

27. The sleeved coupling of claim 16 wherein a portion of the cable extending along at least a majority of the length of the longitudinal member has an outer diameter that is less than an exposed portion of the cable.

28. The sleeved coupling of claim 27 wherein the diameter of the portion of the cable extending along the longitudinal member is from 90% to 99% of the diameter of the exposed portion of the cable.

29. A welding-free, brazing-free, and soldering-free method for attaching a distal end of a helically wound cable to a connection component having a longitudinal member extending from the connection component, the method comprising:
providing a helically wound cable defining a distal end;
providing a connection component having a longitudinal member extending from a face of the connection component, the connection component including a longitudinal member extending from the face and defining a helical groove along the length of the member, the longitudinal member and the helical groove configured to receive the helically wound cable;
positioning the cable onto the longitudinal member such that the cable is disposed in the helical groove defined by the longitudinal member and the cable extends over the length of the longitudinal member;
placing a generally cylindrical sleeve over the cable such that the sleeve extends from the face of the connection component and extends over at least a majority of the length of the longitudinal member, wherein the sleeve defines an inner circumferential wall sized so that at least a majority of the outermost surface regions of the cable along the length of the longitudinal member contact the inner wall, whereby the attachment method is free of welding, brazing, or soldering the cable to the connection component.

30. The method of claim 29 further comprising:
incorporating adhesive along an interface between the cable and at least one of the sleeve and the longitudinal member.

31. The method of claim 30 further comprising:
curing the adhesive.

32. The method of claim 29 further comprising:
forming the distal end of the helically wound cable to exhibit a reduced diameter less than a diameter of the helically wound cable along an exposed region of the cable.
